(19) United States
(12) Patent Application Publication
(10) Pub. No.: US 2011/0163974 A1
(43) Pub. Date: Jul. 7, 2011

(54) MULTI-TOUCH INPUT PROCESSING METHOD AND APPARATUS

(75) Inventors: Sun-il CHOI, Uiwang-si (KR); Jae-hwang LEE, Seoul (KR); Jin-yong AHN, Suwon-si (KR); Eun-gyun KIM, Busan Metropolitan city (KR); Soo-kang BAE, Seongnam-si (KR)

(73) Assignee: SAMSUNG ELECTRONICS CO., LTD., Suwon-si (KR)

(21) Appl. No.: 12/793,754

(22) Filed: Jun. 4, 2010

(30) Foreign Application Priority Data
Jan. 7, 2010 (KR) 10-2010-0001323

(51) Int. Cl. G06F 3/041

(52) U.S. Cl. 345/173

(57) ABSTRACT

A multi-touch input processing method performed by a multi-touch input device and a multi-touch recognition apparatus, the method including: recognizing a touch input from at least one input device; connecting the at least one input device via a radio communication; receiving touch input data from the at least one input device; and executing an application based on the touch input and the touch input data. The apparatus includes a multi-touch processing unit for recognizing a touch input from at least one input device; a radio communicating unit for connecting the at least one input device with the multi-touch processing unit via a radio communication; a touch input data receiving unit for receiving touch input data from the at least one input device, and an application executing unit for executing an application based on the touch input and the touch input data.

### CROSS-REFERENCE TO RELATED PATENT APPLICATION

This application claims the benefit of Korean Patent Application No. 10-2010-0001323, filed on Jan. 7, 2010, in the Korean Intellectual Property Office, the disclosure of which is incorporated herein in its entirety by reference.

### BACKGROUND

1. Field

The exemplary embodiments relate to a multi-touch input processing method and apparatus. More particularly, the exemplary embodiments relate to a multi-touch input processing method and apparatus that use an input device for obtaining screen position information of a multi-touch recognition apparatus and for identifying the input device and recognizing a user's multi-touch of an input device.

2. Description of the Related Art

Touch systems having touch buttons or graphic objects displayed on a display area use fingers or pens, and provide for interactive and intuitive user interfaces.

In general, a touch system uses an event that recognizes a touch input from a user and a coordinate on a screen of the touch system in order to execute a touch input based application. Further, the touch system recognizes, using a camera, a specific pattern of a thimble worn on a user's finger and identifies a user through image processing.

### SUMMARY

The exemplary embodiments provide a multi-touch input processing method and apparatus that use an input device for obtaining screen position information of a multi-touch recognition apparatus and for identifying the input device, an input device' user, and recognizes a multi-touch by a user. A computer readable recording medium stores a program for executing the method.

According to an aspect of the exemplary embodiments, there is provided a multi-touch input processing method performed by a multi-touch recognition apparatus, the method including: recognizing a touch input from at least one input device; connecting the at least one input device via a radio communication; receiving touch input data from the at least one input device; and executing an application based on the touch input and the touch input data.

The touch input data may include an ID of the at least one input device, a user ID of the at least one input device, and screen position information of the multi-touch recognition apparatus, wherein the user ID identifies a user who currently uses the at least one input device from among the at least one user who can use the at least one input device.

The method may further include: managing input device information including the ID of the at least one input device and at least one piece of user information, including the user ID of the at least one user device.

The managing may include: registering, deleting, and renewing the input device information and the at least one piece of user information based on an external input.

The radio communication may include radio frequency identification (RFID), Bluetooth, HomeRF, infrared data association (IrDA), and Zigbee.

According to another aspect of the exemplary embodiments, there is provided a multi-touch input processing method performed by an input device, the method including: when a multi-touch recognition apparatus recognizes a touch input, obtaining screen position information of the multi-touch recognition apparatus; connecting the multi-touch recognition apparatus via a radio communication; and transmitting an ID of the input device, a user ID of the input device, and touch input data including the screen position information to the multi-touch recognition apparatus.

The method may further include: storing input device information including the ID of the input device and user information including the user ID of the input device.

The obtaining of the screen position information may include: obtaining a first coordinate value and a second coordinate value on a screen of the multi-touch recognition apparatus.

The radio communication may include RFID, Bluetooth, HomeRF, IrDA, and Zigbee.

According to another aspect of the exemplary embodiments, there is provided a multi-touch input processing apparatus including: a multi-touch processing unit for recognizing a touch input from at least one input device; a radio communicating unit for connecting the at least one input device via a radio communication; a touch input data receiving unit for receiving touch input data from the at least one input device; and an application executing unit for executing an application based on the touch input and the touch input data.

According to another aspect of the exemplary embodiments, there is provided an input device including: a screen position information obtaining unit for, when a multi-touch recognition apparatus recognizes a touch input, obtaining screen position information of the multi-touch recognition apparatus; a radio communicating unit for connecting the multi-touch recognition apparatus via a radio communication; a touch input data transmitting unit for transmitting an ID of the input device; a user ID of the input device, and touch input data including the screen position information to the multi-touch recognition apparatus.

According to another aspect of the exemplary embodiments, there is provided a computer readable recording medium storing a program for executing the method.

### BRIEF DESCRIPTION OF THE DRAWINGS

The above and other features and advantages of the exemplary embodiments will become more apparent by describing in detail exemplary embodiments thereof with reference to the attached drawings in which:

FIG. 1 illustrates a schematic structure of a multi-touch recognition apparatus according to an exemplary embodiment;

FIG. 2 illustrates a schematic structure of an input device according to an exemplary embodiment;

FIG. 3 illustrates touch input data that is transmitted from an input device to a multi-touch recognition apparatus according to an exemplary embodiment;

FIG. 4 is a flowchart illustrating a method of registering input device information and user information according to an exemplary embodiment;

FIG. 5 is a flowchart illustrating a method of processing a multi-touch input performed in a multi-touch recognition apparatus according to an exemplary embodiment; and

FIG. 6 is a flowchart illustrating a method of processing a multi-touch input performed in an input device according to an exemplary embodiment.

### DETAILED DESCRIPTION

Hereinafter, the exemplary embodiments will be described more fully with reference to the accompanying drawings. In the following description, the sizes of constituent elements shown in the drawings may be exaggerated for clarity of description. Like reference numerals denote like elements throughout.

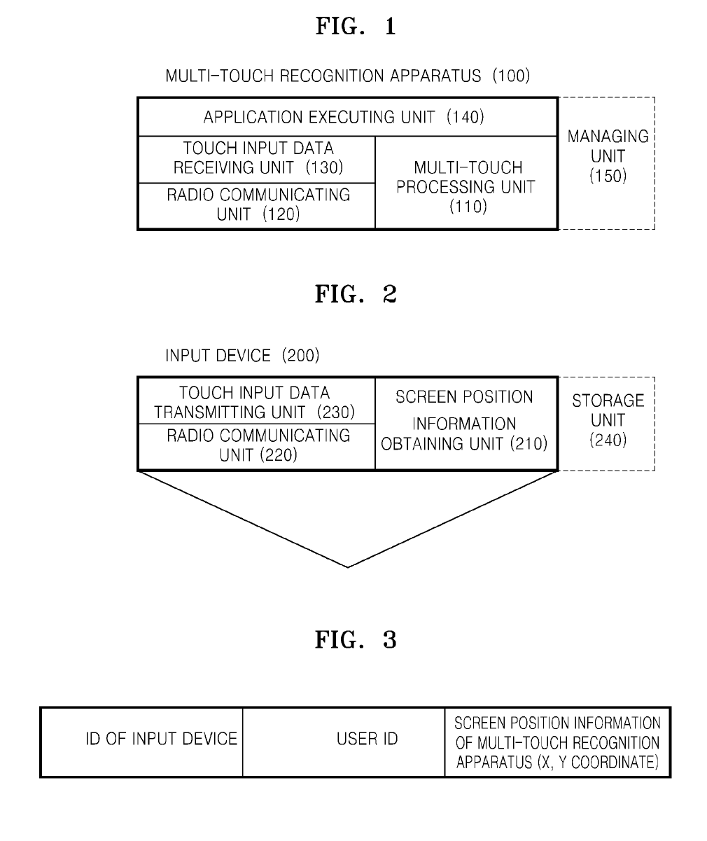

FIG. 1 illustrates a schematic structure of a multi-touch recognition apparatus 100. Referring to FIG. 1, the multi-touch recognition apparatus 100 comprises a multi-touch processing unit 110, a radio communicating unit 120, a touch input data receiving unit 130, and an application executing unit 140.

The multi-touch processing unit 110 recognizes a touch input from at least one input device 200.

The radio communicating unit 120 is connected to the input device 200 via radio communication. Radio communication includes radio frequency identification (RFID), Bluetooth, HomeRF, infrared data association (IrDA), and Zigbee, but other radio communication methods can be applied as would be apparent to one of ordinary skill in the art.

Touch input data receiving unit 130 receives touch input data from input device 200. Touch input data includes an ID of the input device 200, a user ID of the input device 200, and screen position information of multi-touch recognition device 100. The touch input data will be in more detail described with reference to FIG. 3.

Application executing unit 140 executes an application based on the touch input and the touch input data. Application executing unit 140 may retrieve stored input device information based on the ID of input device 200 and stored user information based on the user ID of the input device 200. Application executing unit 140 may execute an application based on the input device information and the user information.

Multi-touch recognition apparatus 100 may further include a managing unit 150, as shown in dashed lines in FIG. 1. The managing unit registers, deletes, and renews the input device information and at least one piece of user information of input device 200, based on an external input. The input device information includes the ID of input device 200. The user information includes the user ID of input device 200.

FIG. 2 illustrates a schematic structure of input device 200 according to an exemplary embodiment. Referring to FIG. 2, input device 200 includes screen position information obtaining unit 210, radio communicating unit 220, and a touch input data transmitting unit 230.

When screen position information obtaining unit 210 recognizes a touch input from multi-touch recognition apparatus 100, screen position information obtaining unit 210 obtains screen position information. Screen position information obtaining unit 210 obtains an (X,Y) coordinate value on a screen of multi-input recognition apparatus 100.

Radio communicating unit 220 is connected to multi-touch recognition apparatus 100 via a radio communication between radio communicating units 120 and 220.

Touch input data transmitting unit 230 transmits touch input data to multi-input recognition apparatus 100. The touch input data includes an ID of input device 200, a user ID of input device 200, and screen position information of multi-touch recognition device 100. The touch input data will be described in more detail with reference to FIG. 3.

Input device 200 may further include a storage unit 240, as shown in dashed lines in FIG. 2. The storage unit stores input device information and at least one piece of user information of input device 200. The input device information includes the ID of input device 200. The user information includes the user ID of the input device 200. One of ordinary skill in the art would recognize that the input device information includes other device information besides the ID of input device 200, and that the user information includes other user information besides the user ID of the user.

FIG. 3 illustrates touch input data that is transmitted from the input device 200 to the multi-touch recognition apparatus 100 according to an exemplary embodiment. Referring to FIG. 3, the touch input data includes an ID of input device 200, a user ID of input device 200, and screen position information of multi-touch recognition apparatus 100.

The user ID identifies a current user of input device 200, from among the at least one user that may use input device 200.

The screen position information of multi-touch recognition apparatus 100 indicates an (X, Y) coordinate. Although the present embodiment describes 2D screen position information, one of ordinary skill in the art would recognize that other types of screen position information may be applied as the screen position information.

According to the exemplary embodiments, it is possible to identify a plurality of users by using user IDs, such as wearing a thimble on a user's finger, and reducing system load, by recognition of a thimble pattern, thereby efficiently using system resources.

Further, according to the exemplary embodiments, a projection type touch system is not needed to recognize the thimble pattern, thereby increasing precision of user identification, compared to recognition of the thimble pattern.

Further, according to the present embodiment, user IDs are used to identify users, for managing users' touch particulars, to realize various user scenarios through user identification.

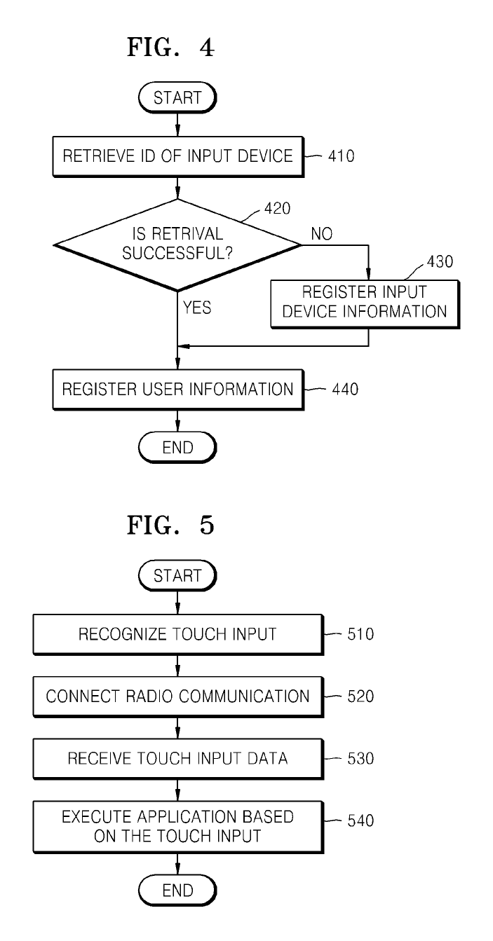

FIG. 4 is a flowchart illustrating a method of registering input device information and user information according to an exemplary embodiment. In operation 610, when a user first purchases input device 200, the user needs to register input device 200 in multi-touch recognition apparatus 100. When there is another user of input device 200, the other user needs to be registered in multi-touch recognition apparatus 100.

In operation 410, the multi-touch recognition apparatus 100 retrieves an ID of input device 200 based on an external input.

In operation 420, multi-touch recognition apparatus 100 determines when the ID of input device 200 exists. When the ID of input device 200 exists, operation 440 proceeds. If not, operation 430 proceeds.

In operation 430, multi-touch recognition apparatus 100 registers the input device information. The input device information includes the ID of input device 200. One of ordinary skill in the art would recognize that the input device information may include other device information besides the ID of input device 200.

In operation 440, multi-touch recognition apparatus 100 registers the user information. The user information includes the user ID. One of ordinary skill in the art would recognize that the user ID information may include other user information besides the user ID.

FIG. 5 is a flowchart illustrating a method of processing a multi-touch input performed in the multi-touch recognition apparatus 100 according to an exemplary embodiment. Referring to FIG. 5, in operation 510, multi-touch recognition apparatus 100 recognizes a touch input from at least one input device 200.

In operation 520, the multi-touch recognition apparatus 100 is connected to the input device 200 via a radio communication. The radio communication includes RFID, Bluetooth, HomeRF, IrDA, and Zigbee but, one of ordinary skill in the art would recognize that other radio communication methods can be applied.

In operation 530, multi-touch recognition apparatus 100 receives touch input data from input device 200. The touch input data includes IDs of input device 200, user IDs of input device 200, and screen position information of touch input data receiving unit 130.

In operation 540, multi-touch recognition apparatus 100 executes an application based on the touch input and the touch input data. The multi-touch recognition apparatus 100 may retrieve stored input device information based on the IDs of input device 200 and stored user information based on the user IDs of input device 200. The multi-touch recognition apparatus 100 may execute an application based on the input device information and the user information.

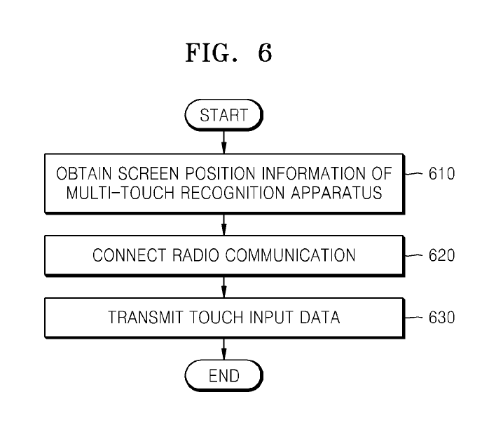

FIG. 6 is a flowchart illustrating a method of processing a multi-touch input performed in the input device 200 according to an exemplary embodiment. Referring to FIG. 6, when input device 200 recognizes a touch input from the touch input data receiving unit (130) of multi-touch recognition apparatus 100, input device 200 obtains screen position information of multi-touch recognition apparatus 100. Screen position information obtaining unit 210 obtains an (X, Y) coordinate value on a screen of multi-input recognition apparatus 100.

In operation 620, input device 200 is connected to the multi-touch recognition apparatus 100 via a radio communication.

In operation 630, input device 200 transmits touch input data to multi-touch recognition apparatus 100. The touch input data includes an ID of input device 200, a user ID of input device 200, and screen position information from the screen position information obtaining unit.

For example, multi-touch recognition device 100 and input device 200 of the exemplary embodiments may include buses coupled to each of the units shown in FIGS. 1 and 2 and at least one processor coupled to the buses, and a memory coupled to the buses to store commands, received messages, or generated messages, and coupled to the processor to execute the commands.

The exemplary embodiments can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed network coupled computer systems so that the computer readable code is stored and executed in a distributed fashion.

While the exemplary embodiments have been particularly shown and described, it will be understood by those of ordinary skill in the art that various changes in form and details may be made therein without departing from the spirit and scope of the exemplary embodiments as defined by the following claims.

What is claimed is:

1. A multi-touch input processing method performed by a multi-touch recognition apparatus, the method comprising:
recognizing a touch input from at least one input device;
connecting the at least one input device to the multi-touch recognition apparatus via a radio communication;
receiving touch input data from the at least one input device; and
executing an application based on the touch input and the touch input data.

2. The method of claim 1, wherein the touch input data includes an ID of the at least one input device, a user ID of the at least one input device, and screen position information of the multi-touch recognition apparatus,
wherein the user ID identifies a user who currently uses the at least one input device, from among the at least one user who can use the at least one input device.

3. The method of claim 2, further comprising: managing input device information including the ID of the at least one input device and at least one piece of user information including the user ID of the at least one user device.

4. The method of claim 3, wherein the managing comprises:
registering, deleting and renewing the input device information, and the at least one piece of user information, based on an external input.

5. The method of claim 1, wherein the radio communication comprises radio frequency identification (RFID), Bluetooth, HomeRF, infrared data association (IrDA), or Zigbee.

6. A multi-touch input processing method performed by an input device, the method comprising:
upon recognition of a touch input by a multi-touch recognition apparatus, obtaining screen position information of the multi-touch recognition apparatus;
connecting the multi-touch recognition apparatus to the input device via a radio communication; and
transmitting an ID of the input device, a user ID of the input device, and touch input data including the screen position information to the multi-touch recognition apparatus.

7. The method of claim 6, further comprising: storing input device information including the ID of the input device and user information including the user ID of the input device.

8. The method of claim 6, wherein the obtaining of the screen
position information comprises: obtaining a first coordinate value and a second coordinate value on a screen of the multi-touch recognition apparatus.

9. The method of claim 6, wherein the radio communication comprises RFID, Bluetooth, HomeRF, IrDA, or Zigbee.

10. A multi-touch input processing apparatus comprising:
a multi-touch processing unit which recognizes a touch input from at least one input device;
a radio communicating unit which connects the at least one input device with the multi-touch processing unit via a radio communication;
a touch input data receiving unit which receives touch input data from the at least one input device; and
an application executing unit which executes an application based on the touch input and the touch input data.

11. The apparatus of claim 10, wherein the touch input data includes an ID of the at least one input device, a user ID of the at least one input device, and screen position information of the multi-touch recognition apparatus,
wherein the user ID identifies a user who currently uses the at least one input device from among the at least one user who can use the at least one input device.

12. The apparatus of claim 11, further comprising: a managing unit for managing input device information including the ID of the at least one input device and at least one piece of user information including the user ID of the at least one input device.

13. The apparatus of claim 12, wherein the managing unit registers, deletes and renews the input device information, and the at least one piece of user information, based on an external input.

14. The apparatus of claim 11, wherein the radio communication comprises RFID, Bluetooth, HomeRF, IrDA, or Zigbee.

15. An input device comprising:
a screen position information obtaining unit which, upon recognition of a touch input from a multi-touch recognition apparatus, obtains screen position information of the multi-touch recognition apparatus;
a radio communicating unit which connects the multi-touch recognition apparatus via a radio communication; and
a touch input data transmitting unit which transmits an ID of the input device, a user ID of the input device, and touch input data including the screen position information of the multi-touch recognition apparatus.

16. The input device of claim 15, further comprising: a storage unit which stores input device information including the ID of the input device and user information including the user ID of the input device.

17. The input device of claim 15, wherein the screen position information obtaining unit obtains a first coordinate value and a second coordinate value on a screen of the multi-touch recognition apparatus.

18. The input device of claim 15, wherein the radio communication comprises RFID, Bluetooth, HomeRF, IrDA, or Zigbee.

19. A computer readable recording medium storing a program, wherein the program, when executed by a processor, causes a computer to execute the method of claim 1.

20. A computer readable recording medium storing a program, wherein the program, when executed by a processor, causes a computer to execute the method of claim 6.
